(19) United States
(12) Patent Application Publication
(10) Pub. No.: US 2024/0134922 A1
(43) Pub. Date: Apr. 25, 2024

(54) METHOD FOR PROVIDING POLITICAL INFORMATION BASED ON A GEOGRAPHICAL LOCATION

(71) Applicant: Chidinma Onweni, Milwaukee, WI (US)

(72) Inventor: Chidinma Onweni, Milwaukee, WI (US)

(21) Appl. No.: 18/048,625

(22) Filed: Oct. 20, 2022

(51) Int. Cl. G06F 16/9537

(52) U.S. Cl. CPC G06F 16/9537

(57) ABSTRACT

A method for accessing political information based on a geographical location providing an application with access to a cloud, downloading the application, generating a username, inputting a geographical location, gathering pollical information based off the geographical location, and presenting the information to the user.

### BACKGROUND OF THE INVENTION

The present invention relates to providing political information and, more particularly, to a method of providing political information based on a geographical location.

Presently, poor education about the political process and candidates leads to poor voter participation.

Users may access political information, such as information on candidates, election dates, voting records for candidates, and other information online. However, the information is not readily presentable and often not easily found. Finding this information is a lot of work and cumbersome.

Moreover, this information is not grouped by a geographical location. As a user is most often constricted to only having a vote in their geographical location, sorting political information by geographical location removes unwanted political information from a user's view.

As can be seen, there is a need for a method for providing political information to a user based on geographical location.

### SUMMARY OF THE INVENTION

In one aspect of the present invention, a method for accessing political information based on a geographical location comprises providing an application with access to a cloud, downloading the application, generating a username, inputting a geographical location, gathering political information based on the geographical location and presenting the information to the user.

Advantageously, the present invention pulls relevant information about voting into one place, to help the voter and increase voting awareness and participation. This makes it easy and better because a user does not need to search multiple sites and locations for election information.

Advantageously, the present invention may be easy to navigate and access while providing education to users.

By using this invention, a person may become aware of local and national elections. The person may acquire all the information needed to make informed decision about who to vote for and what to vote for. This can be done quickly while standing in line to vote. The most important elections that affect our daily lives

The present invention may change that.

These and other features, aspects and advantages of the present invention will become better understood with reference to the following drawings, description, and claims.

### BRIEF DESCRIPTION OF THE DRAWINGS

FIG. 1 is a schematic representation of a system diagram according to an embodiment of the present invention; and

FIG. 2 is a flowchart of method steps according to an embodiment of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims with reference to the drawings.

A general overview of the various features of the invention will be provided, with a detailed description following. Broadly, an embodiment of the present invention provides an application (an app) for a computer, smart phone or smart device with information about candidates, voting, upcoming elections, polls, locations, where the information is arranged or accessed based off a user's geographical location.

The present invention may include a list of geographical locations. Geographical locations may include but are not limited to a country, a state, a county, a city, municipalities, school districts, neighborhoods, and/or other jurisdiction.

A user may select a geographical location for information relevant to that location including political offices, appointed offices, persons holding those offices including history, a website, speeches, voting history, and information on candidates.

In some embodiments of the present invention, a user may access the information via graphical user interface (GUI) in communication with the app. The app may utilize an application programming interface (API) to pull, provide, access, or store, the information.

Information may be input or updated into the present invention by an owner of a server or an artificial intelligence or manually input into the present invention by a user. For example, in a less populated geographical location, a user may manually input desired information into the app for other users to access.

The user may be required to input information when using the app for the first time. Based on this information, the app gives the user information based on his/her location/zip code and all corresponding political information related to such. The political information may include public and political offices, past elections, upcoming elections, available seats, candidates, information about candidates including their websites, links to their speeches, platforms, voting history, public apparencies, voting areas, and polling booths.

A notification feature may notify the user about events, such as upcoming elections in the area or political events.

A cell phone tower may provide a geographical location for the user. Whenever the user travels from one area to another, a cell phone tower may identify a new or updated location for the user.

Information may be collected and saved in a database and/or a cloud. The app may retrieve this information and present it to the user in a simple display on their phone and/or computers

The present invention may be utilized by the user downloading the app and generating a username and password. The username may be generated with an email address. The app may pull all available API and manual data to give the user information about elections and candidates in their area.

The app may pull and provide API on election data into a single location, simplifying the voting process for the user.

The present invention may determine a user's preference and avoid crowding the user's space with too much information. This is achieved by using a given location of the user to match the relevant polling units. The present invention does not just provide data about upcoming elections and candidates but uses an inbuilt mapping system to guide the user to their closest polling unit. This feature would also help the user to be aware of the location of their polling units and plan their journey if they wish to participate in the voting process.

The system of the present invention may include at least one computer with a user interface. The computer may include any computer including, but not limited to, a desktop, laptop, and smart device, such as, a tablet and smart phone. The computer includes a program product, or program code, including a machine-readable program code for causing, when executed, the computer or a portion of the present invention to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The computer-based data processing system and method described above is for purposes of example only and may be implemented in any type of computer system or programming or processing environment, or in a computer program, alone or in conjunction with hardware. The present invention may also be implemented in software stored on a non-transitory computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

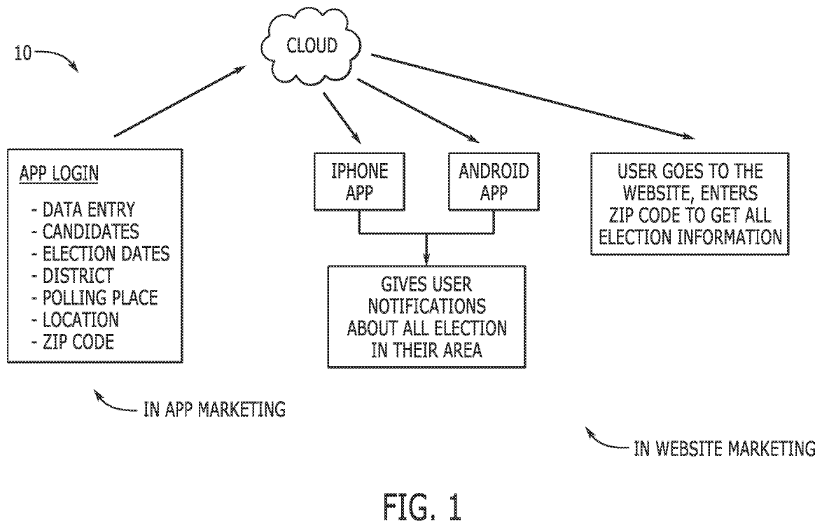

Referring now to the Figures, FIG. 1 is a schematic representation of a system diagram 10 according to an embodiment of the present invention. An app stores information such as data entry, candidates, election dates, polling places, and other polling information based off a geographical location. The app communicates with a cloud. A user downloading the app on their smart device may be given such information and notifications about information in their area. The user may also access the app via a website. The smart device may include a smartphone, computer, or other device.

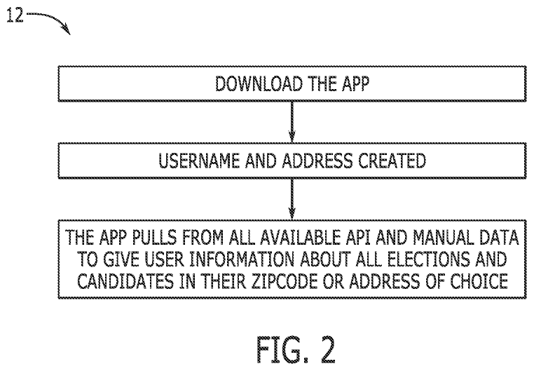

FIG. 2 details steps 12 for use of an embodiment of the present invention. The user may download the app. The user may then generate a username and address. The app then provides the user with political information according to the user's geographic location.

It should be understood, of course, that the foregoing relates to exemplary embodiments of the invention and that modifications may be made without departing from the spirit and scope of the invention as set forth in the following claims.

What is claimed is:

1. A method for accessing political information based on a geographical location comprising:
providing an application with access to a cloud;
downloading the application;
generating a username;
inputting a geographical location;
gathering pollical information based off the geographical location; and
presenting the information to the user.

2. The method of claim 1, further comprising alerting a user with political events in the geographical location.

3. The method of claim 1, wherein the political information is gathered by the app accessing an application programming interface.

4. The method of claim 1, wherein the political information is gathered by the app accessing information manually input by a user.
